(19) United States
(12) Patent Application Publication
(10) Pub. No.: US 2007/0132845 A1
(43) Pub. Date: Jun. 14, 2007

(54) System and method for video presentation of jewelry

(75) Inventor: Isaac Gottesman, Highland Park, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: dimend SCASSI, Ltd., Chicago, IL (US)

(21) Appl. No.: 11/288,617

(22) Filed: Nov. 29, 2005

(51) Int. Cl. H04N 7/18

(52) U.S. Cl. 348/143

(57) ABSTRACT

A system and method are disclosed for providing a real-time remote video feed of an interactive jewelry showing. In an embodiment, a digital video camera captures a video stream of a jewelry item, such as a gem or, more particularly, a diamond, being manipulated by a gemologist. Using a combination of both physical and digital zoom capabilities, the video is configured to provide between 300× and 1000× (variable) magnification. The gemologist may observe the video stream via a display and may further control operation of the system through user input devices such as a mouse and keyboard. A computer system collocated with the gemologist, may be used to receive and process the video stream from the digital video camera. The computer system may then be coupled to a packet network whereby other users may be provided with access to the real-time remote jewelry feed.

### FIELD OF INVENTION

This disclosure relates to methods, systems, and devices for examining jewelry quality.

### BACKGROUND OF THE INVENTION

Jewelry items, such as gems and other precious materials are sought-after for their beauty and rarity. A common complaint among jewelry customers is that the customers do not understand quality differences between various jewelry items. In the diamond market, for instance, differences in cut, color, clarity, weight, and certification can dramatically alter the monetary value of a particular diamond.

The cut of a diamond include factors such as facet pattern, roundness, depth, width, and uniformity of the facets. The diamond's cut can have a dramatic effect on a diamond's brilliance or general brightness. A poor cut will dull the brilliance of the stone—even one with excellent color and clarity. The width and depth affect how light travels through the diamond. A shallow diamond will lose light from the bottom while a deep diamond loses light through the sides.

Color is generally given a letter score with diamonds scored as absolutely colorless rated best. Similarly, clarity is scored based on the number, size, and type of inclusions found in a diamond. The diamond weight, usually measured in carats. A larger diamond is generally valued higher.

These qualities may be certified by an independent laboratory such as the Gemological Institute of America (GIA) or the American Gem Society Laboratories (AGSL).

In higher-end jewelry stores, a gemologist may provide individualized guidance and education to customers so that they understand the various considerations when selecting a jewelry item. However, many potential customers are not prepared to shop at a high-end store—either because of price, location, higher-pressure sales, or some other reason.

Online commerce has been increasingly accepted by consumers. Online jewelry sales are continually growing, however, consumers are still reluctant for several reasons. First, the education and guidance available through the static online resources, although helpful, often do not address specific concerns or questions of potential customers. Second, online pre-recorded videos of diamond showings likewise do not address the individual questions of online customers. Third, although selecting the size, color, and clarity are insufficient for many customers because they want to know which exact diamond they are purchasing and, if possible, see the diamond before purchasing.

### SUMMARY OF THE INVENTION

With these and other issues in mind, a system and method for an interactive jewelry showing is disclosed. A substantially real-time remote feed is part of a multimedia communication session between the gemologist and a remote customer who may be contemplating a purchase.

According to an exemplary embodiment, a video camera captures a video stream showing a jewelry item, such as a diamond being manipulated by a gemologist. The video may be configured to provide a magnification such as 300×. This magnification level may be varied by the gemologist during the showing in order to provide various perspectives on the jewelry item.

The video stream is then received at a first computing device and becomes accessible to the gemologist through a user output (or screen) of the first computing device. The video stream may also be transmitted across a network to a user output of a second computing device accessible to a remote customer. The video stream is provided in substantially real-time, meaning that the video stream is provided with only a short delay of several seconds or fewer. For instance, a delay of 20 seconds would still be considered substantially real time. An additional interactive communication link, such as a voice link, may also be available.

During the showing and video streaming, the gemologist may direct the camera to capture an identification number of the jewelry item being inspected. In a diamond, for instance, an identification number is often etched into the girdle of the cut stone. Showing the identification number to the remote customer may help put the customer at ease that the diamond he will receive is the exact same diamond that was seen in the video stream. In a further embodiment, the gemologist may modify the video stream using a virtual pen to highlight inclusions of the jewelry under inspection.

### BRIEF DESCRIPTION OF THE DRAWINGS

FIG. 1 is a block diagram showing an exemplary architecture according to the invention.

FIG. 2 is a block diagram showing another exemplary architecture according to the invention.

FIG. 3 is a flowchart showing an exemplary operation according to the invention.

FIG. 4 is another flowchart showing an exemplary operation according to the invention.

### DETAILED DESCRIPTION OF THE DRAWINGS

### 1. System Architecture

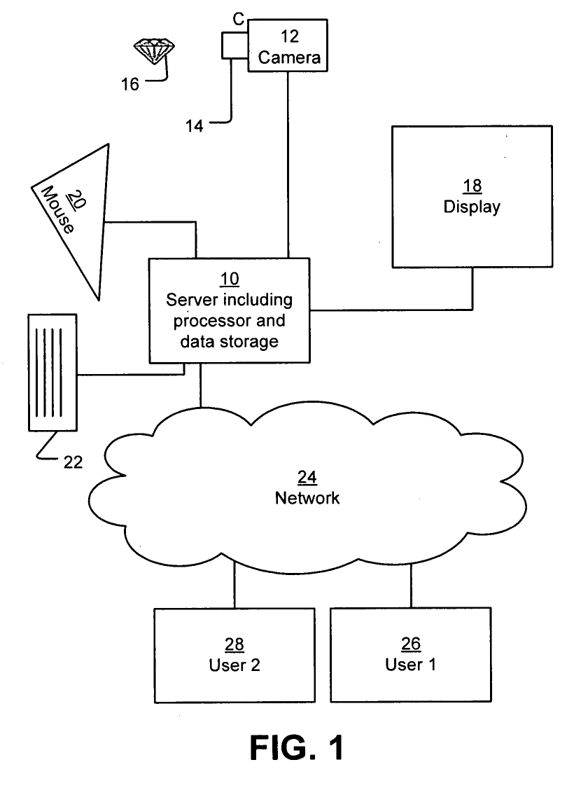

FIG. 1 provides an exemplary system architecture in accordance with an embodiment. The system operates by providing a substantially real-time remote video feed of a jewelry item under inspection. A server 10 may be controlled by an operator, such as a gemologist. As shown, the server 10 includes at least a processor and data storage. A video camera 12 may be communicatively coupled with the server 10 and may capture a video stream of the jewelry item under inspection 16. Here, the video camera 12 is shown as a digital video camera wired to the server. In another embodiment, the video camera may be an analog camera and may pass the video stream through an A/D converter either prior to the video stream reaching the server 10 or at the server 10. (In some embodiments A/D may not be necessary). The jewelry item under inspection may be a gem, such as a diamond, other precious stone, a pearl, metal work such as a ring or earring, or other small jewelry item, for instance. A zoom lens 14 is attached to the video camera 12 and operates to change the convergence of light rays—thus allowing for a magnification of an image of the jewelry item under inspection 16 in the video stream. The lens 14 may be an “objective,” that is, an optical device containing a combination of lenses used to form an image on a focal plane.

According to a preferred embodiment, the zoom lens 14 may be used to change its magnification power. According to an embodiment, the magnification range may include 300× magnification. Further, the magnification range may be from about 200× to 1000×. Although the zoom lens 14 is shown as a physical device attached to the video camera 12, the zoom lens 14 may instead operate as a ‘digital zoom’ or some combination thereof. I.e., the zoom lens 14 may provide 200× variable physical zoom and 5× physical zoom—allowing for 1000× total zoom.

The gemologist may operate the server 10 through one or more user input interfaces. Shown here are two user input interfaces, namely a mouse 20 and keyboard 22. As will be explained later, other user input interfaces, such as a virtual pen, writing pad may be used in various embodiments. A user output interface such as a display 18 may be provided so that the gemologist may receive an output from the server 10.

The server 10 is shown coupled with a network 24. According to the present embodiment, the network 24 is a packet-switched network, such as the Internet. As such, the server 10 may be accessible via an IP address to other devices on the network 24—such as a second computing device 26 or a third computing device 28.

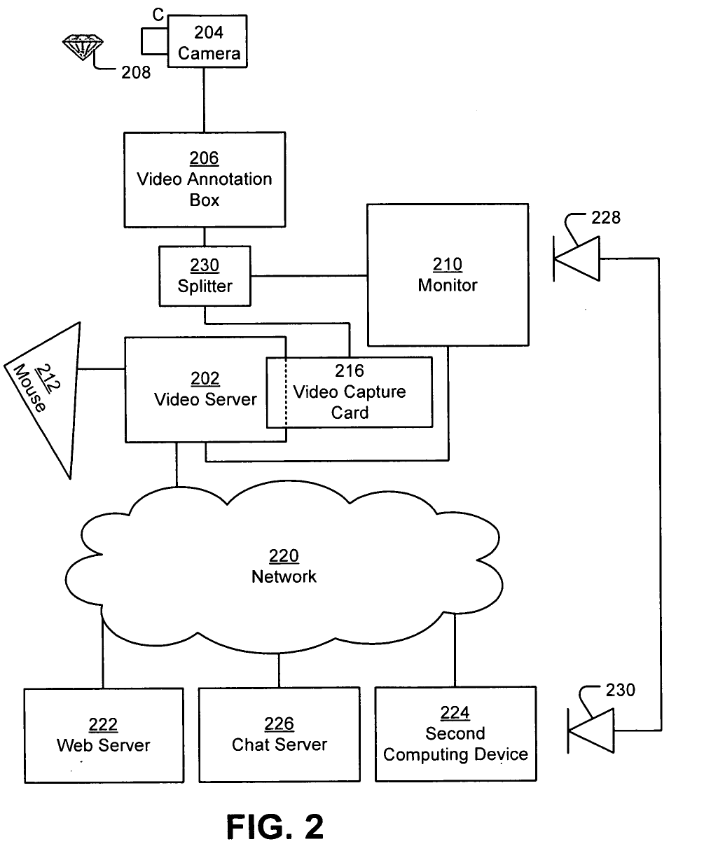

FIG. 2 provides an alternative embodiment of a system architecture in accordance with the invention. A video server 202 may be a computing device, such as a personal computer configured with one or more processors capable of handling a high video throughput. According to the embodiment, the higher quality elements should be assembled in the server 202, this includes sufficient RAM, a high quality disk subsystem, and dedicated video capture card 216. An operating system and installed software should include video capability. In an exemplary embodiment MICROSOFT WINDOWS SERVER 2003 may be used as an operating system along with WINDOWS MEDIA SERVICES and WINDOWS MEDIA ENCODER operating as video enabling software.

According to an embodiment, the video server 202 is configured to operate as a media server, rather than a web server. A media server is currently superior to a web server for streaming video files. As technology advances, other configurations may become more optimal.

The video server 202 may is configured for video capture, video encoding, and video streaming. In an alternative embodiment, the video server 202 may be divided into separate physical devices. In that case, for instance, one device may operate for video capture, another for video encoding, and a third for video streaming. Of course other combinations are available.

A video camera 204 may be coupled with the video server 202 either through a wired connection or via a wireless data connection (or some combination). As shown here, the video camera is coupled to the video server 202 through a plurality of other elements. In an embodiment, the video camera is specifically designed to view gems and other jewelry items. For instance, DiaView, manufactured by IMC-Technologies may operate as the video camera 204. More details regarding DiaView may be found in the document “DiaView Series III Installation Guide and Manual” that is hereby incorporated by reference. The video camera 204 may provide an analog output signal through an S-Video port, for instance.

A video annotation box 206 receives an output video stream from the video camera 204. In an embodiment, the video stream output is an analog video signal, and thus, the video annotation box 206 receives an analog video signal. The video annotation box allows a gemologist to point out features and artifacts of a jewelry item under inspection 208 using a digital pen and tablet. An annotated video signal may then be output through an S-Video port or other port on the video annotation box 206. In an alternative embodiment, the annotation features may be accomplished at the video server through a digital pen (or mouse 212) input. For instance, a writable display may be used at the video server to capture annotations from the gemologist. An example of a video annotation box is VideoChalk manufactured by Boeckeler.

A video splitter 208 may then be used to split the signal coming out of the video annotation box 206 into two signals. One of the outputs may be plugged into a (LCD) monitor 210 for on-site viewing and the other may be plugged into a video capture card 216 of the video server 202. In an embodiment using S-Video, the splitter 208 is an S-Video splitter.

The video capture card 216 is configured as a high resolution and high frame rate capable capture card that receives a video signal (e.g., video stream). In the embodiment using S-Video, the video capture card 216 takes-in the video signal using an S-Video port. The Osprey-230 sold by ViewCast is an exemplary video capture card that provides a number of features including: Cascable architecture allows for multiple Osprey®-230's per chassis; Advanced DMA for ultra-high performance (full 30 fps); Hardware audio gain control; Closed Caption extraction; AVI or extended AVI capture for use with the most popular 3rd party editing and streaming software applications; Hardware Cropping and Bitmap Overlay; PCI-X compatible; Audio Loop-back; Osprey SimulStream Ready; Niagara SCX Ready: Remote encoder management and control.

Running the video server 202 may be a media encoder such as WINDOWS MEDIA ENCODER. The media encoder software works in conjunction with the video capture code 216 to capture the video stream.

The video server may be coupled to a network 220 such as a packet network or the Internet. A web server 222 may host a web site associated with the system. A link to a media player session may be embedded in a web page on the web site. Web content is provided from the web server 222, but an embedded video stream may be provided from the video server 202.

A second computing device 224 may also be communicatively coupled to the network 220 and thus may have access to the web site and to the video server 202. A chat server 226, may provide a second mode of communication between a remote customer at the second computing device 224 and the gemologist and the video server 202. Thus, for instance, the chat server 226 may provide functionality for live text messaging between the second computing device 224 and the video server (or other device accessible to the gemologist) as the video stream of the jewelry item 208 is being streamed over the network 220. An example of a chat server is provided by LivePerson.

In a further embodiment, a first telephone 228 may be accessible to the gemologist and may be communicatively coupled with a second telephone 230 accessible to the remote customer. In this arrangement, the two may speak as they watch and interact with the video stream of the jewelry item 208. The telephones may be any type of telephone including traditional land line, cellular, satellite, VOIP, or some combination, for instance.

### 2. Exemplary Methods of Operation

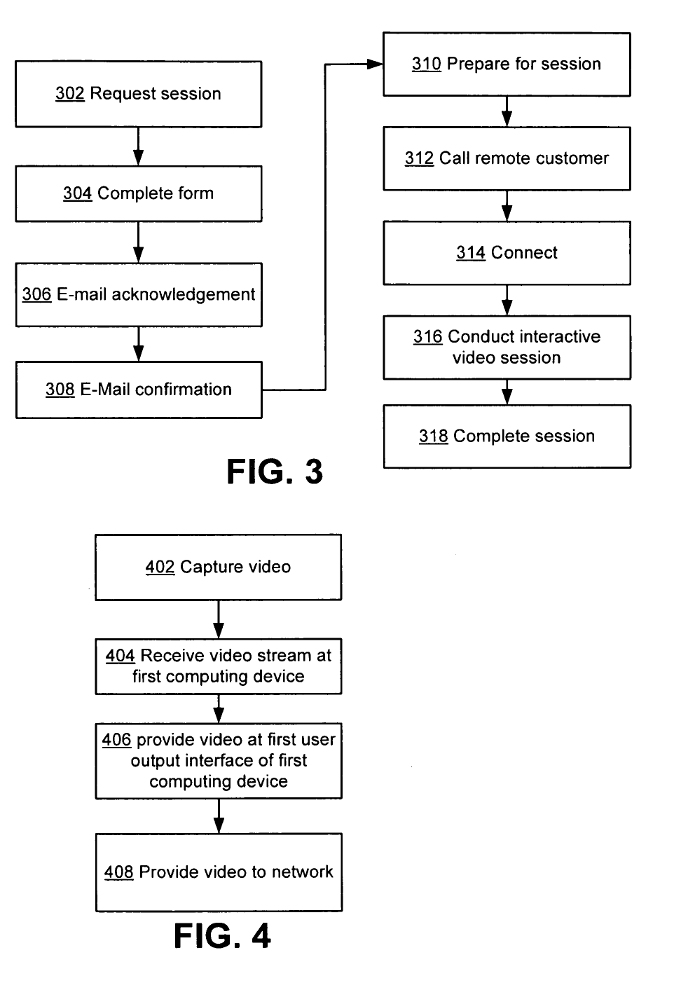

FIG. 3 provides a sequence of events that leads to an interactive video showing according to an exemplary embodiment. At 302 a remote customer examines a particular jewelry item on the web site and via a browser interaction (such as a mouse click) requests an interactive video session of that item. At 304, the remote customer completes a request form requesting an interactive video session at a particular date or time and submits that request. At 306, an e-mail acknowledgement is sent to the remote customer and the request is sent to an administrator of the interactive video system.

At 308, the administrator reads the request, verifies the requested date and time, and responds with an email providing the date and time, URL and username and password of the interactive video session. At 310, a gemologist or other person may prepare for the interactive video session by placing the proper diamond in front of the video camera and starting a video streaming session. At 312, the gemologist may then call the remote customer or otherwise open a communication pathway with the remote customer.

At 314, the remote customer may connect to the video session using the URL, username and password provided in the confirmation e-mail. Password verification may be required before providing the video stream. At 316, the gemologist and remote customer conduct the interactive video session examining the particular jewelry item and perhaps others. Once the session is complete, at 318, the video streaming is stopped.

FIG. 4 provides a flow chart of a method for an interactive jewelry showing with a remote customer. At 402, a video stream is captured with a video camera. The video stream may include at least a 300× magnification potential of a jewelry item under inspection. At 404, the video stream is received at a first computing device. A gemologist (or operator) may be able to access the first computing device through one or more user input and user output interfaces. At 406, the video stream is provided at a first user output interface of the first computing device so that it can be seen by the gemologist. It is expected that the video stream will be provided “live” or substantially real-time at the first user output interface. This means that there should be a minimal or short delay from capturing the video at the video camera 402 and providing the video stream at the first user output interface 406. At 408, the video stream is provided from the first computing device to a network so that it may be accessed by a remote customer. It is expected that the remote customer would use a second computing device to access the video stream and cause it to be displayed at a second user output interface of the second computing device. Again, it is expected that the video stream will be provided “live” or substantially real-time at the network and thus at second user output interface. Here, substantially real-time includes providing the video stream being delayed at least ten seconds. Naturally, a shorter time-delay is usually preferred. If the delay is known, an indication of the delay (such as a number of seconds) may be displayed so that the operator react appropriately.

During the video session, the video stream may be sent to the network and to the remote customer in a Microsoft Media Player format. In an exemplary embodiment, the system supports resolutions between 160×120 and 320×240, as well as frame rates between 15 fps and 29.97 fps. The typical interactive video session is 320×240 at 15 fps, which is embedded in a particular web page on the web site. Of course, other formats may be available as well. Some care should be taken to ensure that the video stream is properly configured to improve its network broadcast efficiency. This may include further digital transformations of the video stream.

At 410, using a second communication pathway, such as a voice pathway (telephone) or chat session, the operator and remote customer may establish an interactive communication link. Thus, as the video is streaming from the video camera through the video server to the second computing device, the operator and remote customer may be discussing qualities of the jewelry item, etc.

In a further embodiment, the system may facilitate a purchase of the exact jewelry item being seen in the video stream. This may operate either through a telephone purchase or through an on-line shopping cart as is well known in the industry. If the remote customer purchases the exact item, the operator should take care to keep track of that item to ensure its proper routing.

During the video session, the operator may zoom in and out on the jewelry item as well as rotate the jewelry item and may also show other jewelry (and non-jewelry) items. For instance, an operator may show a remote customer several grades of diamonds when explaining differences between the grades.

### 3. Diamond Verification

A jewelry item will often have identifiable features such as inclusions or other markings. In the diamond market, many cut diamonds are now engraved along a girdle of the diamond. (The girdle is the edge formed where the top (crown) and bottom (pavilion) of a stone meet. The girdle is the area normally grasped by prongs when a stone is mounted into a setting.) The engraving may include a unique identification number, for instance.

Using the magnification of the video, the identifiable features, such as the identification number, may be clearly visible to the remote customer. Thus, when the jewelry item is sold to the remote customer, the customer may be able to easily verify that the jewelry item received is the same as that shown on the video.

This verification feature may be important in many cases because the purchase of jewelry is often an important and expensive proposition. By providing a way to easily verify that the item seen on the internet is the same as that delivered, a seller can provide a unique and highly valued service.

Other verifications may also be provided to the customer, including certification through an independent laboratory such as the Gemological Institute of America (GIA) or the American Gem Society Laboratories (AGSL). At the close of the sale, the operator may further provide a digital file containing a recorded version of the video session to the remote customer as further verification. In that case, at least a portion of the video stream must have been stored in a video file during the session. Alternatively, screen-shots from the video stream may be stored and then provided to the remote customer.

### 4. Interactive Highlighting

During the interactive video session, the operator may have a need to make some markings on the video to indicate certain aspects of the jewelry item, the operator may also want to write words or make other figures or drawings.

In an exemplary embodiment, a user input interface is provided for modifying the video stream as it is streaming. In a preferred embodiment, a digital pen and tablet mechanism described above are by the operator to modify the video stream. In a further embodiment, the tablet is a display screen so that the operator may more easily identify where the highlighting should occur. Other video steam editing tools may also be used as desired by the operator.

### 5. Program Code

There are a number of ways of arranging program code on the server. In an embodiment, the program code is logically (although perhaps not physically) into several sections. For instance, a first portion of program code may include instructions to receive a video stream showing a jewelry item under inspection; a second portion of program code may include instructions to provide the video stream at a first user output interface of the first computing device in substantially real-time; and a third portion of the program code may include instructions to provide access to the video stream at a second computing device via the network in substantially real-time. A fourth portion of the program code may also be provided that includes instructions to provide functionality for highlighting one or more inclusions of the jewelry item under inspection.

Of course, there are many ways to arrange a program code, both logically and physically, and this description is not intended to limit the present invention to a specific arrangement, but rather to provide a potential example.

### 6. Evaluation Tools

During the interactive video session, a number of evaluation tools may be used to provide further evidence of both qualitative and quantitative aspects of the jewelry item under inspection. For example, an output of a light projection apparatus for showing light leakage may be captured by the video camera. The SYMMETRYSCOPE is one example of such an apparatus. Another tool is an Angular Spectrum Evaluation Tool (A.S.E.T.). The A.S.E.T. may operate as an angular spectrum evaluation apparatus and may be useful to analyze how a diamond collects light from various angles. Other items, such as a scale or colored or black lighting may also be used.

### 7. Third Parties

In an embodiment, other potential customers may also take part in the media session. For instance, the video stream may be publicly accessible so that multiple users may watch the video stream as it is happening. On web site may include an indication reflecting that a video stream is in session and encouraging users to log in. Further, all users may have full or partial access to a conference call. In the partial access scenario, a primary user (the remote customer) may have full interactive access while others have limited interactive access. For instance, the secondary users may be limited so that they can only respond in a chat session or e-mail rather than via the a telephone conversation. Other users may retrieve historical recorded media sessions. Those media sessions may be associated with a particular item of jewelry (e.g., diamond serial no. XXX,YYY) and/or with a particular type of jewelry (e.g., diamond of clarity X, size Y, . . .). If the particular item is unavailable, the user may purchase another item of the particular item in an online interface.

### 8. Conclusion

Exemplary embodiments of the present invention have been described and illustrated. It should be understood that changes and modifications can be made consistent with the invention as claimed.

1. A method for an interactive jewelry showing with a remote customer, the method comprising:
capturing a video stream of a jewelry item under inspection with a video camera, wherein the video stream includes at least a 300× magnification potential of a jewelry item under inspection and wherein the video camera is communicatively linked with a first computing device;
receiving the video stream at the first computing device, wherein the first computing device is accessible to an operator managing the jewelry showing;
providing the video stream at a first user output interface, wherein the first user output interface is associated with the first computing device and accessible to the operator, and wherein the video stream is provided to the first user output interface in substantially real-time;
via a network, providing the video stream at a second user output interface of a second computing device accessible to the remote customer, wherein the video stream is provided to the second user output interface in substantially real-time; and
through a second communication pathway, establishing an interactive communication link between the operator and the remote customer.

2. The method of claim 1 further comprising: facilitating a purchase of the exact jewelry item under inspection by the remote customer.

3. The method of claim 2, wherein the video stream includes an indication of an identification number of the jewelry item under inspection.

4. The method of claim 3, wherein the indication of the identification includes a magnification of a girdle of the jewelry item showing the identification number etched therein.

5. The method of claim 3, further comprising:
storing at least a portion of the video stream in a video file;
in response to the purchase, providing the remote customer with the video file.

6. The method of claim 1, further comprising: a user input interface modifying the video stream by indicating aspects of the jewelry item under inspection.

7. The method of claim 6, wherein the user input interface for modifying the video stream operates as a digital pen and tablet mechanism, and wherein indicating aspects of the jewelry item under inspection includes highlighting inclusions of the jewelry item under inspection.

8. The method of claim 1, wherein the second communication pathway is a voice-connection between the operator and the remote customer.

9. The method of claim 1, wherein the second communication pathway is an instant messaging chat.

10. The method of claim 1, further comprising upon receiving the video stream at the first computing device, digitally transforming the video stream to improve its network broadcast efficiency.

11. The method of claim 1, wherein providing the video stream at the second user output of the second computing device is premised upon receiving, at the first computing device, a password verification from the second computing device.

12. The system of claim 1, wherein providing the video stream at the second user output interface of the second computing device accessible to the remote customer in substantially real-time includes providing the video stream being delayed at least ten seconds.

13. The system of claim 12, further comprising at the first user output interface, displaying an indication of the delay in providing the video stream to the second user output interface.

14. A system for examining jewelry comprising:
a first computing device configured to couple to a network, the first computing device including:
a processor,
data storage; and
program code stored in data storage and executable by the processor, wherein the program code includes:
a first portion of program code that includes instructions to receive a video stream showing a jewelry item under inspection;
a second portion of program code that includes instructions to provide the video stream at a first user output interface of the first computing device in substantially real-time; and
a third portion of the program code that includes instructions to provide access to the video stream at a second computing device via the network in substantially real-time;
a video camera communicatively linked with the first computing device and configured to generate the video stream showing the jewelry item under inspection, wherein the video camera includes an adjustable magnification with a magnification range include 300×;
a first user input interface coupled to the first computing device; and
a second communication pathway operable to establish an interactive communication link between the an operator at the first computing device and a remote customer at the second computing device in substantially real-time.

15. The system of claim 14, wherein the video stream includes an indication of an identification of the jewelry item under inspection, wherein the indication is operable to verify that a remotely purchased jewelry item is the exact jewelry item under inspection.

16. The system of claim 15, wherein the jewelry item under inspection is a cut diamond and wherein the indication of the identification includes a magnification of a girdle of the cut diamond showing the identification number etched therein.

17. The system of claim 14, further comprising an evaluation tool selected from the group of a light projection apparatus for showing light leakage and an angular spectrum evaluation apparatus, the evaluation tool being operational to alter the generated video stream showing the jewelry item under inspection.

18. The system of claim 14, wherein the second communication pathway is a voice communication pathway.

19. The system of claim 14, the first user input interface is operational as a digital pen, and wherein the program code further includes a fourth portion of the program code that includes instructions to provide functionality for highlighting one or more inclusions of the jewelry item under inspection.

20. A method comprising:
through a substantially real-time interactively created video stream showing a jewelry item, providing a unique identifier etched into the jewelry item to a remote customer accessing the video stream from a remote computer through a network, wherein the video stream includes a magnification of at least 300×;
through a second communication pathway, facilitating a purchase of the exact jewelry item under inspection by the remote customer.
